(19) United States
(12) Patent Application Publication
(10) Pub. No.: US 2018/0151083 A1
(43) Pub. Date: May 31, 2018

(54) LEARNING DIAGNOSIS APPARATUS AND METHOD AND ADAPTIVE LEARNING SYSTEM USING THE SAME

(71) Applicant: Electronics and Telecommunications Research Institute, Daejeon (KR)

(72) Inventors: Ho Young YOO, Daejeon (KR); Su Woong LEE, Sejong-si (KR); Hyung Keun JEE, Daejeon (KR)

(73) Assignee: Electronics and Telecommunications Research Institute, Daejeon (KR)

(21) Appl. No.: 15/413,647

(22) Filed: Jan. 24, 2017

(30) Foreign Application Priority Data
Nov. 30, 2016 (KR) 10-2016-0161796

(51) Int. Cl. G09B 5/06; G06F 17/30; G06F 17/18; G09B 5/08; G09B 7/00

(52) U.S. Cl. CPC G09B 5/065; G06F 17/30312; G09B 7/00; G09B 5/08; G06F 17/18

(57) ABSTRACT

The present invention relates to a learning diagnosis apparatus, a method of diagnosing a learner's learning ability, and an adaptive learning system for providing adaptive learning using the diagnosis result. The learning diagnosis apparatus includes a database (DB) configured to store and manage adaptive learning data and store a program for estimating a learner's proficiency to each attribute and recommending learning content and a processor configured to execute the program, wherein the processor calculates a attribute proficiency vector estimation result of a specific learner using information about a solution to a personalized item together with group test solution information.

### CROSS-REFERENCE TO RELATED APPLICATION

This application claims priority to and the benefit of Korean Patent Application No. 10-2016-0161796, filed on Nov. 30, 2016, the disclosure of which is incorporated herein by reference in its entirety.

### BACKGROUND

### 1. Field of the Invention

The present invention relates to a learning diagnosis apparatus, a method of diagnosing a learner's learning ability, and an adaptive learning system for providing adaptive learning using the diagnosis result.

### 2. Discussion of Related Art

Personalized adaptive learning is a technology that intelligently provides contents and services in accordance with the learner's ability and characteristics, thereby enhancing the learning effect conveniently and efficiently.

The adaptive learning technologies that have been commercialized in the past have only relied on the correlation between the contents or merely counted the number of incorrect items to diagnose the weak attributes, and thus there is a problem in that the learning ability of the learner is not sophisticated.

That is, even when personalized adaptive learning is intended to be provided, there is a limitation in that the efficiency and reliability of the adaptive learning system cannot be secured because it is based on an inaccurate diagnosis of learning ability.

### SUMMARY OF THE INVENTION

In order to address the above problems, the present invention proposes a learning diagnosis apparatus and method and an adaptive learning system using the apparatus and method which precisely estimate whether a learner has understood each attribute and automatically recommend personalized learning content to the learner on the basis of the diagnosis result.

In one general aspect, there is provided a learning diagnosis apparatus including: a database (DB) configured to store and manage adaptive learning data and store a program for estimating a learner's proficiency to each attribute and recommending learning content; and a processor configured to execute the program, wherein the processor calculates a attribute proficiency vector estimation result of a specific learner using information about a solution to a personalized item together with group test solution information.

In another general aspect, there is provided a learning diagnosis method including: obtaining group test solution information and information about a solution to a personalized item; analyzing a learner's proficiency of each attribute; providing a learning diagnosis result, which is an analysis result of the learner's proficiency, and adaptive learning content according to the learning diagnosis result; and obtaining information about a solution to an additional personalized item related to a weak attribute which is provided through the adaptive learning content, and re-analyzing the learner's proficiency of each attribute.

In still another general aspect, there is provided an adaptive learning system including: a learner's terminal configured to provide a learner with content related to adaptive learning; an administrator terminal configured to display tutoring data for the adaptive learning; and a server configured to calculate a attribute proficiency vector estimation result of the learner using group test solution information and information about a solution to a personalized item, determine a weak attribute, and provide adaptive learning content related to the weak attribute.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating the overall structure of an adaptive learning system according to one embodiment of the present invention; and

FIG. 2 is a flowchart illustrating a learning diagnosis method according to one embodiment of the present invention.

FIG. 3 is a view illustrating an example of a computer system in which a method for learning diagnosis according to an embodiment of the present invention is performed.

### DETAILED DESCRIPTION OF EXEMPLARY EMBODIMENTS

Advantages and features of the present invention and methods of achieving the same will become apparent by referring to the embodiments described below in detail with reference to the accompanying drawings.

However, the present invention is not limited to the embodiments described below and various modifications may be made thereto. The embodiments are merely provided to thoroughly disclose the invention and to convey the aim of the invention to one of ordinary skill in the art. The present invention is defined by the appended claims.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Before describing embodiments of the present invention, adaptive learning technologies according to a related art will be described first in order to assist those skilled in the art to gain understanding of the embodiments.

According to the related art, the diagnosis of a learner's ability relies on simple statistical data or the subjective judgment of a tutor (teacher), but since the cognitive diagnosis model was proposed, it has become possible to more objectively and accurately diagnose the learner's ability.

The deterministic input, noisy “AND” gate (DINA) model is an archetypal cognitive diagnosis model and estimates whether learners have attained proficiency in each attribute from group test information.

That is, the DINA model estimates the individual learner's proficiency to each attribute from the group test information. When the number of learners is I, the number of items is J, and the number of attributes is K, there are mainly two types of information to be input to the DINA model.

The first type of information is a Q-matrix, which is a binary matrix with the size of “J×K” indicating the correlation between the items used in the group test and the attributes, and the second type of information is an R-matrix, which is a binary matrix with the size of “I×J” indicating whether the learner's response to each item is correct.

From these two types of information, it is estimated whether each of the learners understands each attribute, and the result is output as an “I×K” binary matrix.

The Q-matrix, which is information about mapping between items and attributes, is defined in advance by education experts. The attributes necessary for answering the items are defined in detail and the detailed attribute is mapped to each item.

The i^{th} learner's proficiency vector, i.e., αᵢ which represents learner i's proficiency to each attribute, is a binary vector, and a value of 1 for each element indicates that the attribute is understood and a value of 0 for each element indicates that the attribute is not understood.

The “AND” gate of the DINA model is an assumption that the learner has to know both the item and the mapped attribute in order to get the correct answer.

A latent response vector ηᵢⱼ as a factor for determining whether the i^{th} learner has the skill to answer the j^{th} item is modeled as the following Equation 1.

$${η}_{ij} = [ \frac{{\sum }_{k = 1}^{K} {α}_{ik} \times {q}_{jk}}{{\sum }_{k = 1}^{K} {q}_{jk}} ] \qquad [ Equation 1 ]$$

[α] is the maximum integer that does not exceed α, ηᵢⱼ is expressed as 1 when learner i has the skill to answer item j, ηᵢⱼ is expressed as 0 when learner i has no skill, and 1 is given only when the i^{th} learner knows all the attributes related to the j^{th} item, and it is expressed by the following Equation 2.

$${η}_{ij} = 1 {⇔}^{if and only if} {α}_{ik} = 1 where k ∈ {Ω}_{j} , {Ω}_{j} = \{ k \vert {q}_{jk} = 1 \} \qquad [ Equation 2 ]$$

Here, qⱼₖ is an element of the Q-matrix and indicates whether knowledge of attribute k is required to correctly answer item j. When qⱼₖ is 1, it indicates that the attribute is required, and when qⱼₖ is 0, it indicates that the attribute is not required.

k represents the total number of attributes in the model. αᵢₖ represents whether learner i understands attribute k, and the above-described αᵢ is a vector having αᵢₖ as an element.

“noise” in the DINA model is a noise parameter which indicates the nature of the item, and refers to the assumption of including sⱼ which is a probability that the learner mistakenly answers incorrectly despite the latent response value being 1, and gⱼ which is a probability that the learner's guessed answer is correct despite the latent response value being 0. sⱼ and gⱼ are given by the following Equations 3 and 4, respectively.

sⱼ=P(Xᵢⱼ=0|ηᵢⱼ=1) [Equation 3]

gⱼ=P(Xᵢⱼ=1|ηᵢⱼ=0) [Equation 4]

The item parameters are item-specific parameters that vary in value according to the item and do not vary from learner to learner.

From the above assumption, the probability density function of the response Xᵢⱼ to the j^{th} item by the i^{th} learner with the attribute proficiency vector αᵢ is defined by the following Equation 5, wherein Xᵢⱼ indicates whether learner i's response to item j is correct or incorrect, 1 means a correct answer, and 0 means an incorrect answer.

$$P ( {X}_{ij} = 1 \vert α ) = \{ \begin{matrix}1 - {s}_{j} & when {η}_{ij} = 1 \\ {g}_{j} & when {η}_{ij} = 0\end{matrix} \qquad [ Equation 5 ]$$

According to the above-described DINA model, it is possible to obtain a learner's attribute proficiency vector when all learners have taken the same set of items.

Accordingly, when a personalized item is provided to a specific learner, it is difficult to obtain an accurate attribute proficiency vector of the learner, and thus the present invention proposes a configuration for performing accurate learning diagnosis in a personalized adaptive learning system.

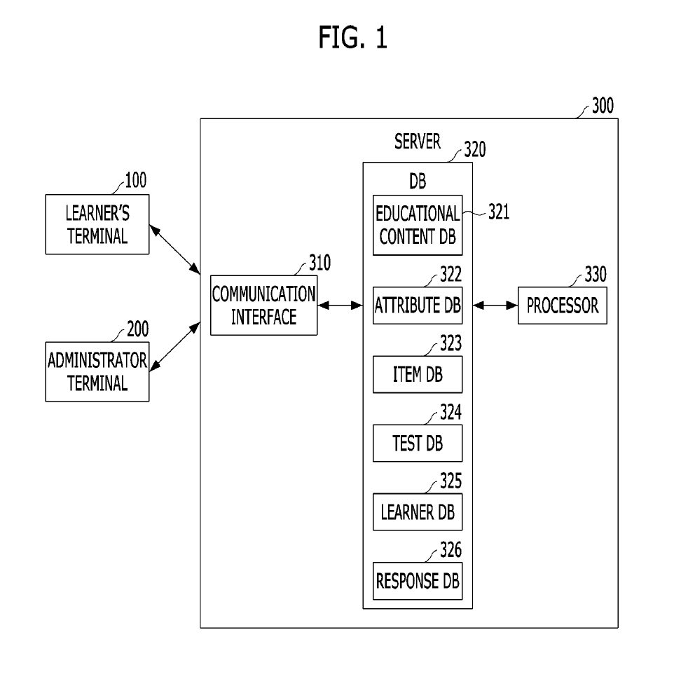

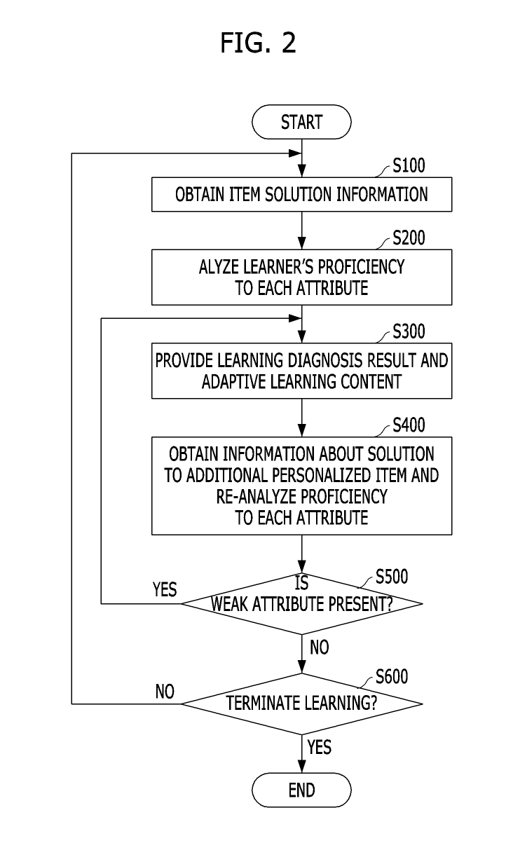

FIG. 1 is a diagram illustrating the overall structure of an adaptive learning system according to one embodiment of the present invention, and FIG. 2 is a flowchart illustrating a learning diagnosis method according to one embodiment of the present invention.

The overall system includes a learner's terminal 100 (including a stationary terminal, such as a personal computer (PC), and a mobile terminal such as a notebook computer, a mobile device, a tablet computer, or the like), an administrator terminal 200, and a server 300.

The server 300 may be configured with a single workstation or a group of a plurality of workstations.

The administrator terminal 200 may be integrated with various learning management systems (LMSes), and the server 300 may be used as an additional function of an existing LMS.

Learners may answer items on a group test or personalized items through the learner's terminal 100 and responses of the learners are stored in a response database (DB) 326 of a DB 320 via a communication interface 310 of the server 300.

The learner's terminal 100 provides the learners with functions, such as group test progress, diagnosis on each attribute and analysis result, recommendation of learning content related to a weak attribute, and personalized exercises, and the administrator terminal 200 provides functions, such as checking of a learner's learning status, management of a learner's grades, attribute-item correlation definition, and learning content creation.

The learner's terminal 100, the administrator terminal 200 and the server 300 are connected via a network and the server 300 diagnoses individual learners' learning ability for each attribute and provides the diagnosis result to an administrator and the learner through the administrator terminal 200 and the learner's terminal 100, respectively.

In addition, the server 300 selects a attribute that is the least understood from the diagnosis result and provides the learning content related to the attribute. The learning content includes video lectures, exercises, and so on.

A processor 330 of the server 300 estimates a learner's proficiency to each attribute, analyzes the weak attribute of the learner on the basis of the learner's diagnosis result, and recommends personalized educational content to each learner.

For example, it is assumed that estimation results of each learner's proficiency to each attribute are as shown in the following Table 1.

TABLE 1

| | Attribute | | |
|---|---|---|---|
| Learner | k = 1 | k = 2 | k = 3 |
| i = 1 | 1 | 0.8 | 0.2 |
| i = 2 | 0.3 | 1 | 0.4 |

A vertical axis of a attribute proficiency vector represents learners and a horizontal axis represents attributes. That is, Table 1 shows that there are two learners and three attributes.

For the first learner, a video lecture or exercise on the third attribute, which has a probability value lower than 0.5, is recommended, and for the second learner, it is analyzed that the first attribute and the third attribute are weak attributes, and learning content related to the first attribute which is more likely to be a weak attribute is recommended first.

The DB 320 of the server 300 is a storage area for information necessary for providing adaptive learning, and specifically the server 300 includes an educational content DB 321, a learner DB 325, a attribute DB 322, a item DB 323, a test DB 324, and the response DB 326.

A diagnosis evaluation text item explanation video, video lectures for each attribute, and video lectures for each item are stored in the educational content DB 321.

Personal information, a learning history, and learning information are stored in the learner DB 322.

A attribute list, individual learners' proficiency to each attribute, attribute-item matching, and attributeual diagrams for attributes are stored in the attribute DB 323.

A item bank, item-attribute matching, item parameters, and correct answers for items are stored in the item DB 324.

A response history, group test information, group test responses, and individual responses to items are stored in the response DB 326.

That is, in the DB 320, the educational content DB 321, the item DB 323, and the attribute DB 322 are correlated in a mutual N-to-N relationship, and the learner DB 325 and the test DB 324 are correlated with the mutually correlated educational content DB 321, item DB 323, and attribute DB 322.

A learning diagnosis apparatus according to one embodiment of the present invention stores and manages adaptive learning data and includes the DB 320 in which a program for estimating a learner's proficiency to each attribute and recommending learning content are stored and the processor 330 which executes the program. The processor 330 calculates an estimation result of a learner's attribute proficiency vector using information about solutions to the personalized items, together with group test solution information.

According to the embodiment of the present invention, the server 300 uses a Q-matrix and an R-matrix which are group test information, and additionally uses a Q′-matrix and an R′-matrix which are information about solutions to personalized items.

When the i^{th} learner answers a total of j′ additional items, the Q′-matrix for the J′ additional items is expressed as “Q′={q′_{j′k}},” and the R′-matrix is expressed as “Yᵢ={Y_{ij′}}.”

In this case, items related to attributes that have been assessed on the existing group test may become usable additional item candidates.

In addition, the personalized items may be additionally provided individually for each learner on the group test, or may be an additional personalized item selected for a weak attribute determined on the group test.

The i^{th} learner's latent response η_{ij′} to the j′^{th} item is given by the following Equation 6.

$${η}_{{ij}^{′}}^{′} = [ \frac{{\sum }_{k = 1}^{K} {α}_{ik} \times {q}_{{j}^{′} k}^{′}}{{\sum }_{k = 1}^{K} {q}_{{j}^{′} k}^{′}} ] \qquad [ Equation 6 ]$$

Item parameters s′_{j′} and g′_{j′} for an additional item cannot be estimated using the existing DINA model because there is only one learner who has answered the item. Thus, when the processor 330 according to the embodiment of the present invention estimates a probability of an answer being mistakenly incorrect and a probability of a guessed answer being incorrect, the processor 330 may apply an average value of the probabilities estimated from results of the group test, or when the personalized items have been used in a previous group test, the processor may apply a diagnosis result estimated from the previous group test to the probabilities.

That is, a case in which an average value of sⱼ and gⱼ estimated from the group test is used is expressed as the following Equation 7.

$${s}_{{j}^{′}}^{′} = \frac{{\sum }_{j = 1}^{J} {s}_{j}}{J} , {g}_{{j}^{′}}^{′} = \frac{{\sum }_{j = 1}^{J} {g}_{j}}{J} \qquad [ Equation 7 ]$$

When the additional items have been used in another previous group test, sⱼ and gⱼ estimated from the previous group test are used.

When the additional items have been used in the previous group tests and the relevant diagnosis results are applied, cumulative information on multiple group tests is required, and an item parameter bank is provided to store and manage item parameter values for each item whenever a diagnosis result is obtained from the group test.

From the above assumption, the probability density function of the i^{th} learner's response to the j′^{th} additional item when a attribute proficiency vector αᵢ of the i^{th} learner is given is defined by the following Equation 8.

P(Y_{ij′}|αᵢ)=Y_{ij′}·{(1−η′_{ij′})g′_{j′}+η′_{ij′}(1−s′_{j′})}+(1−Y_{ij′})·{(1−η′_{ij′})(1−g′_{j′})+η′_{ij′}s′_{j′}} [Equation 8]

Assuming that Y_{ij′} is conditionally independent of a given attribute proficiency vector αᵢ and is the same probability distribution, the probability distribution function is defined by the following Equation 9.

$$P ( {Y}_{i} \vert {α}_{i} ) = {\prod }_{{j}^{′} = 1}^{{J}^{′}} P ( {Y}_{{ij}^{′}} \vert {α}_{i} ) \qquad [ Equation 9 ]$$

Additionally, assuming that Xᵢⱼ and Y_{ij′} are conditionally independent of a given attribute proficiency vector αᵢ, a attribute proficiency vector estimation result αᵢ of the i^{th} learner is defined by the following Equation 10.

$${\hat{α}}_{1} = arg {max}_{α} P ( {α}_{i} \vert {X}_{i} , {Y}_{i} ) = arg {max}_{α} P ( {X}_{i} , {Y}_{i} \vert {α}_{i} ) P ( {α}_{i} ) = arg {max}_{α} P ( {X}_{i} \vert {α}_{i} ) P ( {Y}_{i} \vert {α}_{i} ) P ( {α}_{i} ) \qquad [ Equation 10 ]$$

A processor according to a first embodiment of the present invention estimates a learner's proficiency to each attribute according to group test solution information to determine a weak attribute, provides an additional personalized item related to the weak attribute, and re-analyzes the proficiency to each attribute by taking into consideration a response to the additional personalized item, as described above.

A processor according to a second embodiment of the present invention extracts personalized items and provides the personalized items together with group test items, determines a weak attribute by estimating a learner's proficiency to each attribute according to responses to the provided items, provides an additional personalized item related to the weak attribute, and re-analyzes the learner's proficiency to each attribute using information about solutions to the additional personalized item.

The processor 330 according to the first and second embodiments of the present invention determines whether the learner has successfully learned the weak attribute according to the re-analysis result of the learner's proficiency to each attribute.

When there is still a weak attribute to be learned, a learning diagnosis result is displayed again, and the learning content related to the weak attribute is repeatedly provided.

The processor 330 according to one embodiment of the present invention calculates a attribute proficiency vector estimation result of a learner using a first Q-matrix for correlation between a group test item and a attribute, a first R-matrix for correlation between a learner in the group test and whether the learner's answer is correct, a second Q-matrix (Q′-matrix) for correlation between the personalized item and a attribute, and a second R-matrix (R′-matrix) for correlation between the specific learner and whether the learner's answer to the personalized item is correct, estimates the learner's proficiency to each attribute more accurately by taking into consideration a learning diagnosis result which is provided for individual learners in addition to the group test, and provides adaptive learning according to the estimation.

The learning diagnosis method according to one embodiment of the present invention includes obtaining group test solution information and information about a solution to a personalized item (S100), analyzing a learner's proficiency to each attribute (S200), providing a learning diagnosis result, which is the analysis result from operation S200, and adaptive learning content according to the diagnosis (S300), and obtaining information about a solution to an additional personalized item related to a weak attribute when the additional personalized item is provided through the adaptive learning content and re-analyzing the learner's proficiency to each attribute (S400).

The learning diagnosis method according to one embodiment of the present invention obtains a response to a personalized item that is individually provided to each learner in addition to a group test, or a response to an additional personalized item in operation S100 or S400.

In the case where information about a solution to a personalized item is obtained in S100, the personalized item is a item provided to the learner in addition to a group test, and in the case where a response to the additional personalized item is obtained in S400, the additional personalized item is a response to the additional personalized item provided in S400 according to the learning diagnosis result in S300.

In S200 according to the embodiment of the present invention, the information about a solution to the personalized item, in addition to the group test, is taken into consideration, and a attribute proficiency vector estimation result of a specific learner is calculated using a first Q-matrix for correlation between a group test item and a attribute, a first R-matrix for correlation between a learner in the group test and whether the learner's answer is correct, a second Q-matrix for correlation between the personalized item and a attribute, and a second R-matrix for correlation between the specific learner and whether the learner's answer to the personalized item is correct.

In this case, because the specific learner is the only learner who has answered the personalized item, as item parameters for the item, an average value of item parameters estimated from a group test may be applied, as described above, or when the personalized item has been used in a previous group test, item parameters are estimated from a previous group test diagnosis result and applied.

In S300, learning content is selected and recommended in relation to a weak attribute that is a attribute for which the specific learner's proficiency is equal to or lower than a predetermined value. In S500, it is checked whether there is another weak attribute according to a re-analysis result of the learner's proficiency to each attribute, and in S600, it is checked whether there is a learning termination instruction when no weak attribute is found.

As described above, in the case where the information about a solution to the personalized item in addition to the group test is obtained in S100, the learner's proficiency to each attribute is analyzed and re-analyzed using the information about a solution to the personalized item and information about a solution to an additional personalized item included in the adaptive learning content in S200 and S400.

The learning diagnosis apparatus and method and an adaptive learning system using the apparatus and method according to the present invention accurately diagnose whether a learner has understood each attribute from a result of the learner answering a group test and a personalized item, feedback the diagnosis, and allow identification of a weak attribute and automatic selection and recommendation of learning content related to the weak attribute, thereby increasing the efficiency and reliability of adaptive learning.

The effects of the present invention are not limited to the above effect, and other effects should be clearly understood from the above-described overall descriptions.

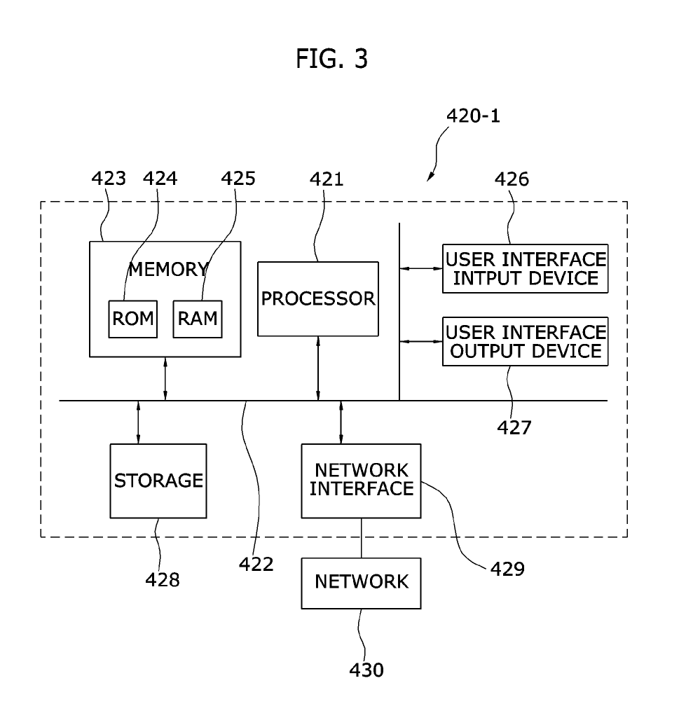

The method for learning diagnosis according to an embodiment of the present invention may be implemented in a computer system or may be recorded in a recording medium. As illustrated in FIG. 3, a computer system may include at least one processor 421, a memory 423, a user interface input device 426, a data communication bus 422, a user interface output device 427, and a storage 428. The components perform data communication via the data communication bus 422.

The computer system may further include a network interface 429 coupled to a network. The processor 421 may be a central processing unit (CPU) or a semiconductor device processing a command stored in the memory 423 and/or the storage 428.

The memory 423 and the storage 428 may include various types of volatile or nonvolatile storage mediums. For example, the memory 423 may include a ROM 424 and a RAM 425.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

REFERENCE NUMERALS

| | |
|---|---|
| 100: LEARNER'S TERMINAL | |
| 200: ADMINISTRATOR TERMINAL | |
| 300: SERVER | 310: COMMUNICATION |
| | INTERFACE |
| 320: DB | 321: EDUCATIONAL |
| | CONTENT DB |
| 322: ATTRIBUTE DB | 323: ITEM DB |
| 324: TEST DB | 325: LEARNER DB |
| 326: RESPONSE DB | 330: PROCESSOR |

What is claimed is:

1. A learning diagnosis apparatus comprising:
a database (DB) configured to store and manage adaptive learning data and store a program for estimating a learner's proficiency to each attribute and recommending learning content; and
a processor configured to execute the program,
wherein the processor calculates a attribute proficiency vector estimation result of a specific learner using information about a solution to a personalized item together with group test solution information.

2. The learning diagnosis apparatus of claim 1, wherein the DB includes an educational content DB, a item DB, and a attribute DB which are correlated in a mutual N-to-N relationship.

3. The learning diagnosis apparatus of claim 2, wherein the DB includes a learner DB and a test DB which are correlated with the mutually correlated educational content DB, item DB, and attribute DB.

4. The learning diagnosis apparatus of claim 1, wherein the processor determines a weak attribute by estimating the specific learner's proficiency to each attribute according to the group test solution information, provides an additional personalized item related to the weak attribute, and re-analyzes the specific learner's proficiency to each attribute by taking into consideration information about a solution to the additional personalized item.

5. The learning diagnosis apparatus of claim 1, wherein the processor extracts and provides the personalized item together with a group test item, determines a weak attribute by estimating the specific learner's proficiency to each attribute according to responses to the provided items, provides an additional personalized item related to the weak attribute, and re-analyzes the specific learner's proficiency to each attribute using information about a solution to the additional personalized item.

6. The learning diagnosis apparatus of claim 1, wherein, when the specific learner's proficiency to a attribute is equal to or lower than a predetermined value, the processor recommends supplementary learning material related to the attribute to the learner.

7. The learning diagnosis apparatus of claim 1, wherein the processor calculates a attribute proficiency vector estimation result of the specific learner using a first Q-matrix for correlation between a group test item and a attribute, a first R-matrix for correlation between a learner in the group test and whether the learner's answer is correct, a second Q-matrix for correlation between the personalized item and a attribute, and a second R-matrix for correlation between the specific learner and whether the learner's answer to the personalized item is correct.

8. The learning diagnosis apparatus of claim 7, wherein the processor takes into consideration a latent response vector for the personalized item of the specific learner and calculates the attribute proficiency vector estimation result of the specific learner by estimating a probability of an answer being mistakenly incorrect despite the latent response vector having a value of 1 and a probability of a guessed answer being correct despite the latent response vector having a value of 0.

9. The learning diagnosis apparatus of claim 8, wherein the processor estimates the probability of an answer being mistakenly incorrect and the probability of a guessed answer being correct by applying an average value of corresponding probabilities estimated from results of the group test.

10. The learning diagnosis apparatus of claim 8, wherein, when the personalized item has been used in a previous group test, the processor applies a diagnosis result estimated from the previous group test to the probability of an answer being mistakenly incorrect and the probability of a guessed answer being correct.

11. A learning diagnosis method comprising:
obtaining group test solution information and information about a solution to a personalized item;
analyzing a learner's proficiency to each attribute;
providing a learning diagnosis result, which is an analysis result of the learner's proficiency, and adaptive learning content according to the learning diagnosis result; and
obtaining information about a solution to an additional personalized item related to a weak attribute which is provided through the adaptive learning content, and re-analyzing the learner's proficiency to each attribute.

12. The learning diagnosis method of claim 11, wherein the analyzing of the learner's proficiency includes calculating a attribute proficiency vector estimation result of the learner using a first Q-matrix for correlation between a group test item and a attribute, a first R-matrix for correlation between a learner in the group test and whether the learner's answer is correct, a second Q-matrix for correlation between the personalized item and a attribute, and a second R-matrix for correlation between the specific learner and whether the learner's answer to the personalized item is correct.

13. The learning diagnosis method of claim 11, wherein the providing of the learning diagnosis result and the adaptive learning content includes selecting and recommending learning content related to a weak attribute that is a attribute for which the learner's proficiency is equal to or lower than a predetermined value.

14. The learning diagnosis method of claim 11, wherein the analyzing and re-analyzing of the learner's proficiency of each attribute includes taking into consideration a latent response vector for the personalized item of the learner, calculating a attribute vector estimation result of the learner by estimating a first probability of an answer being mistakenly incorrect despite the latent response vector of the learner having a value of 1 and a second probability of a guessed answer being correct despite the latent response vector having a value of 0, and applying an average value of corresponding probabilities estimated from results of the group test to the first and second probabilities, or when the personalized item has been used in a previous group test, applying a diagnosis result estimated from the previous group test to the first and second probabilities.

15. An adaptive learning system comprising:
a learner's terminal configured to provide a learner with content related to adaptive learning;
an administrator terminal configured to display tutoring data for the adaptive learning; and
a server configured to calculate a attribute proficiency vector estimation result of the learner using group test solution information and information about a solution to a personalized item, determine a weak attribute, and provide adaptive learning content related to the weak attribute.

16. The adaptive learning system of claim 15, wherein the server includes:
a communication interface configured to perform an interface function for communication with the learner's terminal and the administrator terminal;
a processor configured to estimate a learner's proficiency to each attribute; and
a database (DB) configured to store adaptive learning data,
wherein the processor calculates the attribute vector estimation result of the learner using a first Q-matrix for correlation between a group test item and a attribute, a first R-matrix for correlation between a learner in the group test and whether the learner's answer is correct or incorrect, a second Q-matrix for correlation between the personalized item and a attribute, and a second R-matrix for correlation between the specific learner and whether the learner's answer to the personalized item is correct.

17. The adaptive learning system of claim 16, wherein the server analyzes the learner's proficiency of each attribute in order to determine the weak attribute, for which the server calculates a attribute proficiency vector estimation result of the learner by estimating a first probability of an answer being mistakenly incorrect despite a learner's latent response vector having a value of 1 and a second probability of a guessed answer being correct despite a latent response vector having a value of 0, and applies an average value of corresponding probabilities estimated from results of the group test to the first and second probabilities, or when the personalized item has been used in a previous group test, applies a diagnosis result estimated from the previous group test to the first and second probabilities.
